(19) United States
(12) Patent Application Publication
(10) Pub. No.: US 2022/0095642 A1
(43) Pub. Date: Mar. 31, 2022

(54) FILLING COMPOSITION FOR A CONFECTIONARY PRODUCT

(71) Applicant: The Hershey Company, Hershey, PA (US)

(72) Inventors: Xiaoying Wang, Hummelstown, PA (US); Jonathan Stahl, Palmyra, PA (US); Brian Baker, Millersburg, PA (US); Linda Wright, Lancaster, PA (US)

(73) Assignee: The Hershey Company, Hershey, PA (US)

(21) Appl. No.: 17/424,066

(22) PCT Filed: Jan. 21, 2020
(86) PCT No.: PCT/US2020/014489

§ 371 Date: Jul. 19, 2021

Related U.S. Application Data
(60) Provisional application No. 62/795,272, filed on Jan. 22, 2019.

(51) Int. Cl. A23G 1/54; A23G 1/40; A23G 1/32

(52) U.S. Cl. CPC A23G 1/54; A23V 2002/00; A23G 1/325; A23G 1/40

(57) ABSTRACT

A reduced calorie filling composition may include a chocolate component and an aqueous component. The chocolate component may be present in an amount from about 30% to about 70% by weight of the reduced calorie filling composition. The aqueous component may include water in an amount from about 9% to about 20% by weight of the reduced calorie filling composition. In addition, the aqueous component may include a sweetener component in an amount from about 5% to about 30% by weight of the reduced calorie filling composition. The aqueous component may also includes a humectant in an amount from about 2% to about 10% by weight of the reduced calorie filling composition. A confectionery product may be a finished reduced calorie confectionery product having a reduced calorie coating composition on the reduced calorie filling composition. The finished reduced calorie confectionery product may be a reduced calorie truffle.

### TECHNICAL FIELD

This application is a PCT international patent application of and claims the priority of U.S. provisional patent application, Ser. No. 62/795,272 filed on Jan. 22. 2019, and incorporates the subject matter thereof in its entirety.

### BACKGROUND

Low calorie sweeteners are increasingly being considered as sugar substitutes in food products. For example, allulose (D-allulose, D-psicose) is a monosaccharide sugar that may provide about 70% of the sweetness of sucrose with only about 5% of the calories (about 0.2 cal/g). There is, however, considerable room for improvement to provide a reduced calorie chocolate filling composition that is suitable for use in a reduced calorie confectionery product such as a truffle.

### BRIEF SUMMARY

Embodiments generally relate to a tilling composition. More particularly, embodiments relate to a reduced calorie chocolate filing composition, a reduced calorie confectionery product including the reduced calorie chocolate filling composition, and/or methods of making thereof.

Embodiments include a reduced calorie filling composition. The reduced calorie filling composition may include a chocolate component in an amount from about 30% to about 70% by weight of the reduced calorie filling composition. The reduced calorie filling composition may include an aqueous component. The aqueous component may include water in an amount from about 9% to about 20% by weight of the reduced calorie filling composition, a sweetener component (e.g., a syrup including a low calorie sweetener) in an amount from about 5% to about 30% by weight of the reduced calorie filling composition, optionally a water soluble bulk component (e.g., a low calorie soluble fiber) or a fiber syrup in an amount from about 0% to about 30% by weight of the reduced calorie filling composition, and preferably a humectant component (e.g., a humectant) in an amount from about 2% to about 10% by weight of the reduced calorie tilling composition.

Embodiments include a reduced calorie confectionery product. The reduced calorie confectionery product may include a reduced calorie coating composition disposed on a reduced calorie filling composition. The reduced calorie confectionery product may be in the form of a truffle.

Embodiments include a method of preparing a reduced calorie filling composition including mixing a chocolate component and, an aqueous component to form the reduced calorie filling composition. Embodiments further include joining a reduced calorie coating composition with the reduced calorie filling composition to form a reduced calorie confectionery product. Embodiments further include forming the reduced calorie coating composition.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of a reduced calorie confectionery product according to an embodiment.

FIG. 2A is a flowchart of a method to prepare a reduced calorie filling composition, a reduced calorie coating composition, and/or a reduced calorie confectionery product according to an embodiment.

FIG. 2B is a flowchart of a method to prepare a reduced calorie filling composition, a reduced calorie coating composition, and/or a reduced calorie confectionery product according to an embodiment.

FIG. 2C is a flowchart of a method to prepare a reduced calorie filling composition, a reduced calorie coating composition, and/or a reduced calorie confectionery product according to an embodiment.

FIG. 2D is a flowchart of a method to prepare a reduced calorie filling composition, a reduced calorie coating composition, and/or a reduced calorie confectionery product according to an embodiment.

### DESCRIPTION OF EMBODIMENTS

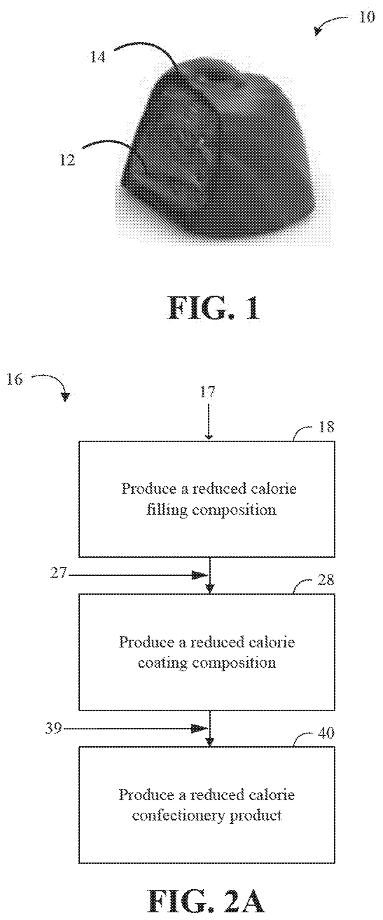

Turning now to FIG. 1, a reduced calorie confectioneiy product 10 including a reduced calorie filing composition 12 is shown according to an embodiment. A reduced calorie filling composition 12 may include a chocolate component having a chocolate material and/or a chocolate-like material. The chocolate material is derived from cacao seeds and may include a cocoa solid, cocoa butter, and/or cocoa liquor. Meanwhile, the chocolate-like material has at least a part of cocoa butter in chocolate replaced by another fat (e.g., butterfat, a vegetable fat, cocoa butter equivalent (CBE), cocoa butter substitute (CBS), cocoa butter replacement (CBR), etc.). In one example, the chocolate component of a reduced calorie filling composition 12 includes dark chocolate, baking chocolate, milk chocolate, sweet chocolate, semi-sweet chocolate, white chocolate, and so on. The chocolate component may include, for example, a commercially available chocolate sold under the trademark Symphony® (Hershey Chocolate & Confectionery Corp.). The chocolate component may be present in an amount from about 30% by weight to about 70% by weight, preferably from about 58% by weight to about 72% by weight, relative to the total weight of a reduced calorie filling composition.

A reduced calorie filling composition 12 may further include a sweetener component having a substance that sweetens (e.g., a natural sweetener, an artificial sweetener, etc.). The sweetener component may include, for example, sugar, invert sugars, sucrose, corn syrup, sorbitol, glucose, fructose, dextrose, galactose, xylose, agave nectar, stevia, sucralose, honey, molasses, allulose, erythritol, xylitol, sorbitol, maltitol, aspartame, acesulfame potassium, saccharin, alitame, tagatose, and so on. In addition, the sweetener component may be present in a crystalline form, an amorphous form, and/or a syrup form. Notably, the sweetener component may include a reduced calorie sweetener (e.g., a low/zero calorie sweetener). Such sweeteners include, for example, tagatose (1.5 cal/g,), sugar alcohols (e.g., erythritol (0.24 cal/g), maltitol (2.0 cal/g), lactitol (2.0 cal/g), isomalt (2.0 cal/g etc.), and so on.

Preferably, the sweetener component includes allulose or allulose syrup based on its relatively pleasant taste, relatively high stability in water, water activity (NO reduction property, and stabilization property. Moreover, commercially available allulose syrup (e.g., 70% solids) is relatively stable and relatively easy to handle. Crystalline allulose, however, may also be relatively easy to handle and/or process. For example, crystalline allulose may be dissolved in a solvent (e.g., water) and/or an aqueous solution for use in a filling composition. A saturated allulose solution might, however, be avoided to minimize precipitation (e.g., crystal formation) during storage. In one example, allulose may be in amount less than about 77% by weight, preferably about 70% by weight, relative to the total weight of an allulose syrup (e.g., 72° F). Thus, for example, allulose may be present in an amount of about 7.0% by weight when allulose syrup (70%) is used in an amount of about 10% by weight relative to the total weight of a reduced calorie filling composition.

A reduced calorie filling composition 12 may further include an aqueous component (e.g., an aqueous solution). The aqueous component may include water that is mixed with an ingredient (e.g., a sweetener, a flavoring agent such as coffee, tea, juice, alcohol, etc.) before being mixed with a chocolate component to form a reduced calorie filling composition. In one example, water is from a water-based beverage. Water that is added to form the aqueous component may be determined based on water content of other components/ingredients in the aqueous component. In one example, additional water might be omitted when allulose syrup (70%) is used in an amount of about 30% by weight relative to the total weight of a reduced calorie filling composition 12 to provide about 9% of water which when mixed with a chocolate component having less than about 1% water provides from about 9% to about 10% total water content. Moreover, water from the aqueous component is safe for human consumption potable water). For example, potable water may come from surface sources and/or ground sources and be treated to levels that that meet state and federal standards for consumption. In one example, the National Primary Drinking Water Regulations (NPDWR) from the United States Environmental Protection Agency provide legally enforceable standards and treatment techniques applicable to public water systems.

Notably, the composition of the aqueous component is important to calorie content, micro-stability, texture stability, and/or sensory properties of a filling composition. For example, the aqueous component may be present in an amount not less than about 22% by weight, more preferably not less than about 25% by weight, relative to the total weight of a reduced calorie filling composition 12 to provide a suitable consistency for filling deposition and/or consumption. In one example, an aqueous component in an amount of about 28.3% by weight relative the total weight of a reduced calorie filling composition 12 is mixed with a chocolate component (e.g., incited chocolate) in an amount of about 71.7% by weight relative to the total weight of the reduced calorie filling composition 12 to provide a creamy texture in a form that is easy to deposit. The addition of potable water, however, increases the Aw and affects stability and/or shelf life of a confectionery product. Water from the aqueous component may therefore be present in an amount less than about 20% by weight, preferable less than about 17% by weight, relative to the total weight of a reduced calorie filling composition 12 to achieve an Aw less than about 0.72, preferably less than about 0.65, which is suitable to ensure micro-stability of a finished reduced calorie confectionery product, In one example, added potable water may be present in an amount of about 13% by weight relative to the total weight of a reduced calorie filling composition 12 to provide total water content of about 16.5% by weight relative to the total weight of the reduced calorie filling composition 12 when about 3.5% of water content is from another component water from syrup, water from chocolate, etc.).

A reduced calorie filling composition 12 may further include a humectant component. For example, the aqueous component may be a mixture of a sweetener, added potable water, and a humectant that operates to stabilize a filling composition (e.g., reduces Aw, improves softness, etc) andior to lengthen the shelf life of a reduced calorie filling composition 12 (e.g., moisture control and sugar crystallization control). The humectant component may include, for example, a non-ionic polyol such as glycerin, sorbitol, etc. A humectant may be present in an amount from about 2% by weight to about 10% by weight relative to the total weight of a reduced calorie filling composition 12 when total water content is present in an amount of about 9% by weight to about 20% by weight relative to the total weight of the reduced calorie filling composition. In one example, glycerin is present in an amount of about 5% by weight relative to the total weight of a reduced calorie filling composition 12 when added potable water is present in an amount of about 13% by weight relative to the total weight of the reduced calorie filling composition 12 and/or when total water content is present in an amount of about 16.5% by weight relative to the total weight of the reduced calorie filling composition 12 for an Aw of less than about 0.72.

A reduced calorie filling composition 12 may further include additional components such as, for example, a binder, an emulsifier, a flavor, a fiber, a protein, a fruit piece, etc. For example, low calorie soluble fibers or fiber syrups may be used in combination with allulose or other low calorie sugar solutions and/or syrups such as inulin powder, syrup, polydextrose powder, polydextrose syrup, corn fiber, corn fiber syrup, and so on. In one example, soluble fibers such as polydextrose (1.0 cal/g) and/or insoluble fibers such as cocoa powders (2.2 cal/g) might be used. Flavors may be derived from an extract such as from an almond extract, an orange extract, a lemon extract, a raspberry extract, a hazelnut extract, a vanilla extract, coffee extract, tea extract, and so on.

In the illustrated example of FIG. 1, the reduced calorie confectionery product 10 is in the form of a finished reduced calorie confectionery product (e.g., a reduced calorie truffle) and has a reduced calorie coating composition 14 in the form of a shell that envelops the reduced calorie filling composition 12. Generally, a reduced calorie coating composition 14 may be in the form of a shell and/or a layer for a finished or an unfinished product. A reduced calorie coating composition 14 and a reduced calorie filling composition of a same reduced calorie confectionery product may include a same or a different component independently selected from a chocolate material, a sweetener, a humectant, water, a binder, an emulsifier, a flavor, a fiber, a fat, a protein, etc. For example, a reduced calorie coating composition 14 may include a chocolate-like material while a reduced calorie filling composition has a chocolate material and lacks chocolate-like material. Thus, for example, a finished reduced calorie confectionery may be a reduced calorie chocolate confectionery product and/or a reduced calorie chocolate-like confectionery product (e.g., comprising cocoa butter replacers, cocoa butter equivalents or substitutes).

In one example, a reduced calorie coating composition 14 may include cocoa liquor and cocoa butter as a chocolate component. For a milk chocolate shell, however, other milk solids may be utilized such as milk powders, lactose free. milk powders, milk fat, etc. In addition, confectionery fats other than cocoa butter (e.g., CBE, CBS, CBR) might be used for a lower cost (e.g., non-SOI chocolate). A reduced calorie coating composition 14 may further include sweeteners such as sugars (e.g. sucrose and lactose). Moreover, a reduced calorie coating composition 14 may include soluble fibers that are useful as low calorie bulk agents and that provide a good textured and tasteful chocolate. For example, a reduced calorie coating composition 14 may include corn fibers (e.g., resistant maltodextrin) and/or chicory root fiber (e.g., Inulin). Other low-calorie dry ingredients might also be used in a coating composition including, for example, low calorie sweeteners such as allulose and tagatose, sugar alcohols such as erythritol, maltitol, lactitol, isomalt, other soluble fibers such as polydextrose, insoluble fibers such as cocoa powders, and so on.

A reduced calorie coating composition 14 may include lecithin and PGPR to reduce viscosity and to achieve suitable theology for the manufacture of a shell. Other emulsifiers with similar functions may be used such as ammonium phosphatides (ITN), oat lecithin, and so on. A reduced calorie coating composition 14 may also include milk fat (e.g., anhydrous milk fat) to impart a rich creamy flavor while maintaining firmness. In addition, a reduced calorie coating composition 14 may include vanillin as a flavor. Alternatively or additionally, other flavors may be used such as artificial flavors (e.g., ethyl vanillin, etc.), natural flavors (e.g., vanilla, etc.), oil-based flavors (e.g., mint, cherry, strawberry, hazelnut, cinnamon, orange, etc.), etc. Moreover, a combination of low-calorie sweeteners and protein powders might be used to achieve a higher protein shell. For example, a combination with whey protein, soy protein, pea protein, etc., might be used to achieve a higher protein shell.

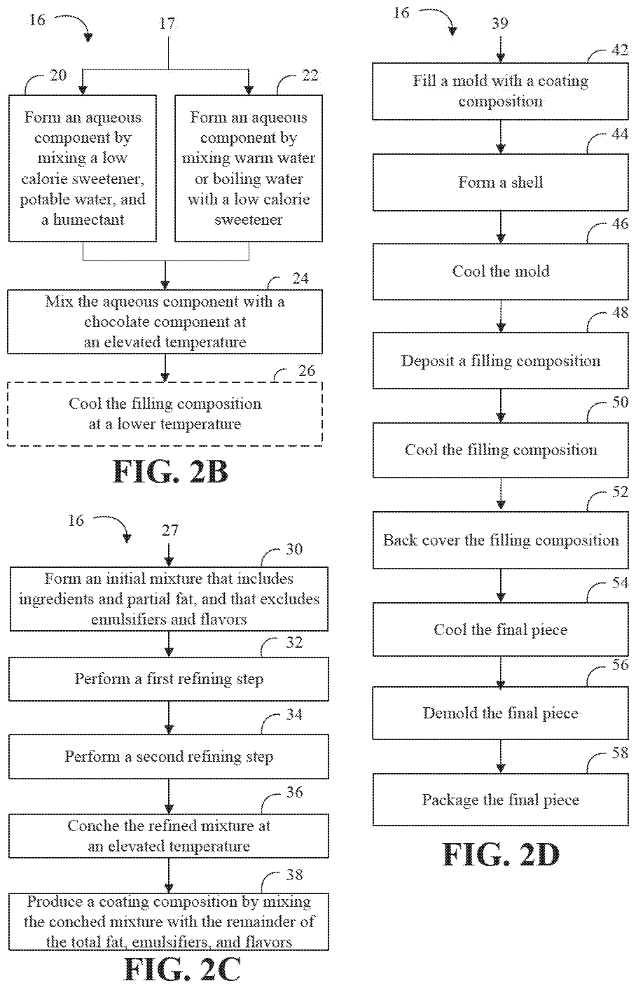

FIGS. 2A-2D show a method 16 according to an embodiment of the present disclosure. A machine may implement one or more aspects of the method 16 automatically. For example, an aspect of the method 16 may be implemented as a set of logic instructions stored in a machine- or computer-readable storage medium such as random access memory (RAM), read only memory (ROM), programmable ROM (PROM), firmware, flash memory, 3DXP memory, etc., in configurable logic such as, for example, programmable logic arrays (PLAs), field programmable gate arrays (FPGAs), complex programmable logic devices (CPLDs), or any combination thereof. For example, computer program code to carry out operations shown in the method 16 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In illustrated FIG. 2A, step 18 of method 17 produces a reduced calorie filling composition 12. The reduced calorie filling composition 12 may include, for example, a chocolate component and an aqueous component. In one example, the aqueous component may preferably include a humectant component. The aqueous component may be prepared first by dissolution of all dry ingredients in potable water and mixing with other syrup ingredients until uniform. The mixing may be completed at room temperature (e.g., if no dry ingredients are used in an aqueous solution). A warm temperature (e.g., about 100° F. to about 150° F.) might be used to dissolve soluble fibers or other dry ingredients. In illustrated FIG. 2B, method 17 is shown in more detail. Step 20 forms an aqueous component by mixing a low calorie sweetener (e.g., 70% allulose syrup), potable water, and a humectant (e.g., glycerin) at room temperature, for example from about 70° F. to about 80° F. Alternatively, step 22 forms an aqueous component by mixing warm water or boiling water with a sweetener and a bulk agent (e.g., 70% allulose syrup and soluble coin fiber).

The aqueous component may then be mixed with melted chocolate in a batch mixer (e.g., a Hobart mixer) until a uniform mixture is achieved. A continuous mixer may also be used to mix chocolate and the aqueous component. In the illustrated example, step 24 mixes the aqueous component from step 20 or the aqueous component from step 22 with a chocolate component melted chocolate) at an elevated temperature, for example from about 90° F. to about 120° F., preferable from about 93° F. to about 97′F. Notably, a pre-made chocolate material and/or a pre-made chocolate-like material may be mixed with an aqueous component. In addition, an ingredient of a chocolate component (e.g., an ingredient used in chocolate making, with or without pre-milling for smaller particles) may be mixed directly with an aqueous component. Step 26 then optionally cools the filling composition (e.g., may be omitted if for example no warm water or boiling water is used to dissolve dry ingredients) at a lower temperature, for example from about 80° F. to about 88° F., preferable from 85° F. to 88° F. Step 24 and/or step 26, therefore, produce a relatively smooth and uniform reduced calorie filling composition 12 ready to deposit into shells).

In illustrated FIG. 2A, step 28 of method 27 produces a reduced calorie coating composition 14 of FIG. 1. The reduced calorie coating composition 14 might be in the form of a shell in a finished reduced calorie confectionery product. In one example, step 28 may process a reduced calorie chocolate shell with traditional chocolate process methods. Step 28 might also implement other chocolate processes. For example, step 28 might utilize a ball-mill particle size reduction process. Step 28 might also mix pre-milled ingredients with fats to form chocolate or chocolatey candy.

In illustrated FIG. 2C, method 27 is shown in more detail. In the illustrated example, step 30 forms an initial mixture that excludes emulsifiers and flavors. The initial mixture includes only part of the total fat in the reduced calorie coating composition 14 together with other ingredients (e.g., sugar, cocoa powder, chicory root fiber, erythritol). In one example, the fat content of the reduced calorie coating composition 14 is about 30.8%. Thus, about 24.6% of fat may be present in the initial mixture. The initial mixture may be heated, for example at a temperature from about 95° F. to about 110° F., and then refined in one or more steps.

Step 32 performs a first refining step to provide ingredients with an average particle size from about 30 μm to about 150 μm, preferably from about 35 μm to about 50 μm, and step 34 performs a second refining step to provide ingredients with an average particle size from about 15 μm to about 40 μm, preferably from about 20 μm to about 25 μm. Step 36 then conches the refined mixture at an elevated temperature, such as about 131°F, for a period of time, such as from about 2 hr to about 5 hr. Notably, more fat may be added at step 36. For example, 26.9% of fat in the reduced calorie coating composition 14 may be present at step 36. Step 38 then produces a final mixture that forms the reduced calorie coating composition 14 by mixing the coached mixture with the reminder of the total fat, emulsifiers, and flavors. For example, cocoa butter auditor anhydrous milk fat may be added to provide an additional 3.9% of fat together with lecithin, PGPR, and vanillin to produce the reduced calorie coating composition 14.

Step 40 produces a final reduced calorie confectionery product. The final reduced calorie confectionery product may be in the form of a reduced calorie truffle with a reduced calorie chocolate outer shell and a reduced calorie chocolate ganache core. Step 40 may, for example, apply traditional process for making truffles such as shell making (e.g., wet shell mold, cold stamp, etc.), center depositing, center cooling, chocolate backing, final cooling, demoulding, wrapping, and/or packaging.

In illustrated FIG. 2D, method 39 is shown in more detail. In the illustrated example, step 42 fills a mold with chocolate. Step 42 may, for example, fill the mold with the reduced calorie coating composition 14 from step 38. Step 44 forms a shell via, for example, cold stamping. Step 46 cools the mold to solidify the chocolate. Step 48 deposits a filling composition, Step 48 may, for example, deposit the reduced calorie filling composition 12 from step 24 or step 26 in the shell. Step 50 cools the filling composition and step 52 back covers the filling composition with the reduced calorie coating composition 14. Step 54 cools the final piece. Step 56 demolds the final piece and step 58 packages the final piece. Temperatures used for cooling are routinely determinable based on, for example, concentration of ingredients, size of parts of a confectionery product, processes used to make a final piece, etc.

While independent steps and/or a particular order has been shown for illustration purposes, it should be understood that one or more of the steps of the method 16 may be combined, omitted, bypassed, re-arranged, and/or flow in any order. Moreover, any or all steps of the method 16 may be manually implemented (e.g., with human intervention, etc.).

Filling Composition: Example 1

Table 1 illustrates a first example filling composition according to an embodiment. The filling composition was manufactured based on one or more aspects of the method 16 (FIGS. 2A-2B), already discussed. As shown in Table 1, chocolate commercially available under the trademark Symphony® is present in an amount from about 68% to about 72%, allulose syrup (70%) is present in an amount from about 5% to about 30%, added potable water is present in an amount from about 9% to about 20%, and glycerin is present in an amount from about 2% to about 10%. In one example, the low calorie sweetener component (allulose syrup) provides substantially less than 1% of the calories per gram in the filling composition.

TABLE 1
First Example Filling Compositions

| Ingredient | % by weight |
|---|---|
| Chocolate | 68-72 |
| Allulose syrup (70%) | 5-30 |
| Water | 9-20 |
| Glycerin | 2-10 |

Filling Composition: Example 2

Table 2 illustrates a second example filling composition according to an embodiment. The filling composition was manufactured based on one or more aspects of the method 16 (FIGS. 2A-2B), already discussed. As shown in Table 2. chocolate commercially available under the trademark Symphony® is present in an amount from about 68% to about 72%, allulose syrup (70%) is present in an amount from about 5% to about 30%, and added potable water is present in an amount from about 9% to about 20%. In one example, the low calorie sweetener component (allulose syrup) provides less than 1% of the calories per gram in the filling composition.

TABLE 2
Second Example Filling Composition

| Ingredient | % by weight |
|---|---|
| Chocolate | 68-72 |
| Allulose syrup (70%) | 5-30 |
| Water | 9-20 |

Coating Composition: Example

Table 3 illustrates an example coating composition according to an embodiment. The coating composition was manufactured based on one or more aspects of the method 16. ((FIGS. 2A and 2C). already discussed. As shown in Table 3, sugar is present in an amount from about 10% to about 20%, soluble corn fiber is present in an amount from about 5% to about 15%, chocolate liquor is present in an amount of about 30% to about 40%, cocoa powder is present in an amount from about 1% to about 5%, cocoa butter is present in an amount from about 5% to about 10%, chicory root fiber is present in an amount from about 10% to about 15%, erythritol is present in an amount of about 15% to about 20%, AMF is present in an amount from about 1% to about 5%, lecithin is present in an amount from about 0.1% to about 1.0%, and PGPR and Vanillin are each present in an amount from about 0.01% to about 0.10%. In one example, calories per gram in the coating composition are from about 3.25 cal/g to about 3.72 cal/g.

TABLE 3
Example Coating Composition

| Ingredient | % by weight |
|---|---|
| Sugar | 10-20 |
| Soluble corn fiber | 5-15 |
| H135 Liquor | 30-40 |
| Cocoa powder | 1-5 |
| Cocoa butter | 5-10 |
| Chicory Root Fiber | 10-15 |
| Erythritol | 15-20 |
| AMF | 1-5 |
| Lecithin | 0.1-1.0 |
| PGPR | 0.01-0.10 |
| Vanillin | 0.01-0.10 |

Confectionery Product: Example 1

Table 4 illustrates a first example finished confectionery product according to an embodiment. The confectionery product is in the form of a truffle that is prepared from an embodiment of the first filling composition (Example 1) and an embodiment of the example coating composition, already-discussed. The confectionery product vas manufactured using one or more aspects of the method 16 (FIGS. 2A-2D), already discussed. As shown in Table 4, greater than 50% of the confectionery product is coating composition (e.g., shell) and less than 50% is filling composition (e.g., center). In one example, the confectionery product has about 40 cal/piece of 10.4g. In addition, the calorie density of the confectionery product was about 3.8 cal/g, which was about 40% reduction as compared with conventional truffles of 6.4 cal/g (having a fat based cream center).

The fat content of the coating composition was about 30.8%. Using low-calorie ingredients at different levels, a coating composition with a calorie density lower than 3 cal/g at about 29.7% fat content can also be achieved.

TABLE 4
First Example Product

| | | Calories per Piece |
|---|---|---|
| Product Part | % by weight | (10.4 g) |
| Coating | >50 | 22.05 |
| Center | <50 | 17.35 |
| Total | 100.0 | 39.40 |

Confectionery Product: Example 2

Table 5 illustrates a second example finished confectionery product according to an embodiment. The confectionery product is in the form of a truffle that is prepared from an embodiment of the second example filling composition (Example 2) and an embodiment of the example coating composition, already discussed. The confectionery product was manufactured using one or more aspects of the method 16 (FIGS. 2A-2D), already discussed. As shown in Table 5, less than 50% of the confectionery product is coating composition (e.g,., shell) and greater than 50% is filling composition (e.g., center). In one example, the confectionary product has about 42 cal/piece of 11.8g. In addition, the calorie density of the confectionery product was about 3.5 cal/g.

TABLE 5
Second Example Product

| | | Calories per Piece |
|---|---|---|
| Product Part | % by weight | (11.8 g) |
| Coating | <50 | 15.6 |
| Center | >50 | 26.24 |
| Total | 100.00 | 41.84 |

It should be understood that percentages discussed herein with regard to a component relates to a weight by weight 4w/w) basis for illustrative purposes, which is the proportion of a particular substance within a mixture as measured by weight (and/or mass). It should also be understood that the indefinite articles “a” or “an” carry the meaning of “one or more” or “at least one”. As used in this application, a list of items joined by the terms “one or more of”, “at least one of” can mean any combination of the listed terms. For example, the phrases “one or more of A, B and C” and “one or more of A, B or C” can mean A; B; C; A and B; A and C; B and C; or A, B and C. Similarly, a list of terms joined by the term “and so on” or “etc.” can mean the list is not an exhaustive list and may be any combination of the listed terms. For example, the phrase “A, B, C, and so on” can mean A; B; C; A and B; A and C; B and C; or A. B and C.

Those skilled in the art will appreciate from the foregoing description that the broad techniques of the embodiments may he implemented in a variety of forms. Therefore, while the embodiments have been described in connection with particular examples thereof, the true scope of the embodiments should not be so limited since other modifications will become apparent to the skilled practitioner upon a study of the drawings and the specification described above and/or as follows.

We claim:

1. A reduced calorie confectionery product comprising:
a reduced calorie filling composition including:
a chocolate component in an amount from about 30% to about 70% of the reduced calorie filling composition; and
an aqueous component including:
water in an amount from about 9% to about 20% of the reduced calorie filling composition;
a sweetener component in an amount from about 5% to about 30% of the reduced calorie filling composition, wherein the sweetener component includes a reduced calorie sweetener; and
a humectant in an amount from about 2% to about 10% of the reduced calorie filling composition; and
a reduced calorie coating composition on the reduced calorie filling composition.

2. The reduced calorie confectionery product of claim 1, wherein the coating composition is in the for a of one or more of a shell or a layer.

3. The reduced calorie confectionery product of claim 1, wherein the coating composition includes a chocolate component including one or more of a chocolate material or a chocolate-like material.

4. The reduced calorie confectionery product of claim 3, wherein the coating composition includes one or more of a sweetener, a milk powder, an emulsifier, a flavor, a fiber, a fat, or a protein.

5. A reduced calorie filling composition comprising:
a chocolate component in an amount from about 30% to about 70% of the reduced calorie filling composition; and
an aqueous component including:
water in an amount from about 9% to about 20% of the reduced calorie filling composition; and
a sweetener component in an amount from about 5% to about 30% of the reduced calorie filling composition, wherein the sweetener component includes a reduced calorie sweetener.

6. The filling composition of claim 5, wherein the chocolate component includes one or more of a chocolate material or a chocolate-like material.

7. The filling composition of claim 6, wherein the chocolate component includes one or incite of a sweetener, an emulsifier, a milk powder, a flavor, a fiber, a fat, or a protein.

8. The filling composition of claim 5, wherein the chocolate component is in an amount from about 68% to about 72% of the reduced calorie filling composition.

9. The filling composition of claim 5, wherein the sweetener component is in one or more of a crystalline form, an amorphous form, or a syrup form.

10. The filling composition of claim 9, wherein the low calorie sweetener is one or more of crystalline allulose or syrup allulose.

11. The filling composition of claim 5, wherein the aqueous component is in an amount of not less than about 22% of the reduced calorie filling composition.

12. The filling composition of claim 5, wherein the water includes added potable water in an amount from about 0% to about 15% of the reduced calorie filling composition and water from at least one other component in an amount of about 1.5% to about 9.5% of the reduced calorie filling composition.

13. The filling composition of claim 5, wherein the aqueous component further includes a humectant in an amount from about 2% to about 10% of the reduced calorie filling composition.

14. The filling composition of claim 13, wherein the humectant component includes glycerin in an amount of about 5% of the reduced calorie filling composition.

15. A method of making a reduced calorie filling composition comprising:
mixing a chocolate component and an aqueous component to form the reduced calorie filling composition, wherein the aqueous component includes water in an amount from about 9% to about 20% of the reduced calorie filling composition and a sweetener component in an amount from about 5% to about 30% of the reduced calorie filling composition, wherein the sweetener component includes a reduced calorie sweetener.

16. The method of claim 15, wherein the sweetener component is allulose syrup (70%) in amount from about 5% to about 30% of the reduced calorie filling composition.

17. The method of claim 15, wherein the aqueous component further includes a humectant in an amount from about 2% to about 10% of the reduced calorie filling composition.

18. The method of claim 15, further including joining a reduced calorie coating composition with the reduced calorie filling composition to form a reduced calorie confectionery product.

19. The method of claim 18, further including producing the reduced calorie coating composition.

20. The method of claim 18, wherein the reduced calorie confectionery product is in the form of a truffle.
